(19) United States
(12) Patent Application Publication
(10) Pub. No.: US 2007/0222310 A1
(43) Pub. Date: Sep. 27, 2007

(54) Electric Motor Comprising a Mounting Device

(76) Inventor: Thomas Drexlmaier, Wurzburg (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/568,361

(22) PCT Filed: Feb. 24, 2005
(86) PCT No.: PCT/EP05/50776

§ 371 Date: Oct. 26, 2006

(30) Foreign Application Priority Data
Apr. 29, 2004 (EP) 04010238.6

(51) Int. Cl. H02K 5/24

(52) U.S. Cl. 310/51

(57) ABSTRACT

An adapter fixture (3) for axial assembly purposes is provided by directing said adapter fixture, which accommodates magnet shells (5, 6) at the stator end and is provided with a molded-on first bearing bracket (3.1) at one end thereof, through a motor housing such that the same radially engages underneath the motor housing while the other end thereof can be placed on or fixed to a second separate bearing bracket (4) along with an intermediate adapter part (2) that overlaps the motor housing (1) and is provided with radial noise-damping mounting webs (2.1; 2.2) with the aid of the motor housing (1) which can be tightly clamped to said second bearing bracket (4).

### CROSS-REFERENCE TO RELATED APPLICATIONS

This application is a U.S. national stage application of International Application No. PCT/EP2005/050776 filed Feb. 24, 2005, which designates the United States of America, and claims priority to European application number EP 04010238.6 filed Apr. 29, 2004, the contents of which are hereby incorporated by reference in their entirety.

### TECHNICAL FIELD

The invention relates to an electric motor, in particular a fan motor, comprising a mounting device for noise-dampened installation into a radial external motor mounting part.

### BACKGROUND

Known from EP 0 848 477 B1 is a noise-dampened mount for an electric motor with fan blades attached to its rotor shaft in a radial external motor mounting part; the electric motor can be attached to its motor housing or reflux part axially with a radial external adapter part in the form of a sleeve, and can be reciprocally locked into the operational stop position, which has noise-dampening radially protruding mounting lugs that can be clamped against them during installation in an external motor mount.

Known from EP 1 108 150 B1 is a similar electric motor, in which a bearing support with a bearing retainer is molded as a single piece on an adapter part encompassing the motor housing of the electric motor radially on the exterior with radially protruding mounting lugs on the one front-facing end.

Known from U.S. Pat. No. 3,789,250 A and DE 23 02 947 A1 is a dynamo machine, in particular for motor-driven small units of motor vehicles, with a cup-shaped plastic housing with a cup bottom designed as a first bearing bracket and a second bearing bracket that can be attached to its open housing end, as well as a molded mounting flange primarily radially distant; permanent magnets can be affixed tangentially on the front side as well as on the rotor side and in their one axial direction by installation on the cup-shaped plastic housing, as well as radially outward and in their other axial direction by externally supporting pole shoes to be screwed radially to the cup-shaped plastic housing.

Known from DE 195 17 668 A1 is a direct current machine energized by a permanent magnet with a magnetic shell support that can be inserted into a motor housing cover axially with a one-piece first bearing bracket installed on the one axial end of the motor housing cover and with a second bearing bracket that can be axially inserted on the other axial end of the motor housing cover and which can be locked thereto.

Known from DE 16 13 368 A1 is a small motor energized by a permanent magnet with a plastic frame in the form of a clamp with a first bearing bracket integrated into its clamp foot, and a second bearing bracket attached to its free clamp ends, as well as with stop braces running axially for accommodating permanent magnet segment shells and with annular slits concentric to the motor shaft direction for the insertion of annular cylindrical reflux plates.

Known from U.S. Pat. No. 6,060,799 A is a motor energized by a permanent magnet with a cup-shaped plastic magnet holder incorporating a main bearing in its cup base, it being possible to insert said magnet holder axially into a reflux motor housing as a component that can be equipped in advance with magnet shells.

### SUMMARY

According to the object of the present invention, an effective reduction in noise with simultaneous stable motor design is to be achieved in a mass-produced compact electric motor in a manner that is efficient in terms of the technology for production and assembly.

This object can be achieved by an electric motor with mounting device for noise-dampened installation into a radial external motor mounting part, comprising a motor housing that can be positioned by means of axial installation assembly between an axial front-side bearing bracket as a stator reflux part for stator-side energizing magnets, respectively, a noise-dampened intermediate adapter part externally overlapping the motor housing radially at least partially for the noise-dampened accommodation of the electric motor in the radial external motor mounting part, an adapter fixture engaging under the motor housing for holding the energizing magnets, the one bearing bracket on the front side being molded on the corresponding one axial end of the adapter fixture, and a two-way position anchor between the motor housing, the adapter fixture as well as the intermediate adapter part on the one hand and the other bearing bracket that can be mounted on the front side as a separate component on the other hand, created by axially bracing the motor housing with the other bearing bracket.

In one embodiment, the electric motor may further comprise a configuration of the noise-dampened intermediate adapter part overlapping the motor housing in the area of the other axial end of the adapter fixture. In one embodiment, the intermediate adapter part and the adapter fixture respectively can be designed as discrete components. In one embodiment, the intermediate adapter part and the adapter fixture can be designed as a one-piece component able to be mounted in the sense of an axial installation assembly. In one embodiment, the motor may comprise a one-piece transition from the adapter fixture into the intermediate adapter part in the area of the other end of the adapter fixture. In one embodiment, the one-piece transition between the adapter fixture and the intermediate adapter part can be braced by fixing the position between the motor housing and the other bearing bracket. In one embodiment, the motor may comprise radially protruding limit stops at the other end of the intermediate adapter part; and radially protruding limit stops at the other end of the adapter fixture. In one embodiment, the motor may comprise radially protruding limit stops at the one end of the motor housing, and radially protruding limit stops at the other end of the intermediate adapter part. In one embodiment, the intermediate adapter part or the adapter fixture respectively can be axially braced by fixing the position between the motor housing and the other bearing bracket via the radially protruding limit stops. In one embodiment, tangential front edges of the energizing magnets in the form of magnet shells may abut retainers of the adapter fixture or wherein axial front sides of the energizing magnets may abut axial limit stops of the adapter fixture or axial limit stops of the intermediate adapter part. In one embodiment, the magnet shells can be axially braced by fixing the position between the motor housing and the other bearing bracket. In one embodiment, the adapter fixture and/or the intermediate adapter part can be designed as a plastic part. In one embodiment, the adapter fixture and/or the intermediate adapter part can be designed as a plastic injection molding part. In one embodiment, the electric motor can be a fan motor. In one embodiment, the radially protruding limit stops may be in the form of a circumferential, radially protruding edge.

By bracing the motor housing that acts as a reflux part with the other bearing bracket, the adapter fixture accommodating the magnets as well as the intermediate adapter part serving as the dampened mount can be positioned and fixed in a simple and secure manner after the axial mounting or insertion of the motor housing through axial pressure thereof in mutually permanent association.

The assembly effort can be further reduced by forming the adapter fixture and the intermediate adapter part as one piece with a transition part connected in the area of the other axial end of the adapter fixture, and this component can be positioned along with the motor housing when the latter is braced with the other bearing bracket when connected during assembly.

### BRIEF DESCRIPTION OF THE DRAWINGS

The invention as well as further advantageous embodiments of the invention are explained in greater detail in the illustration below on the basis of exemplary embodiments presented schematically; shown therein:

FIG. 1, 3, 5 in a perspective explosion diagram in each case, three different devices according to the invention with respect to the implementation and fixing of intermediate adapter part and adapter fixture;

FIG. 2, 4, 6 the devices according to the invention according to FIG. 1, 3, 5 in an axial section.

### DETAILED DESCRIPTION

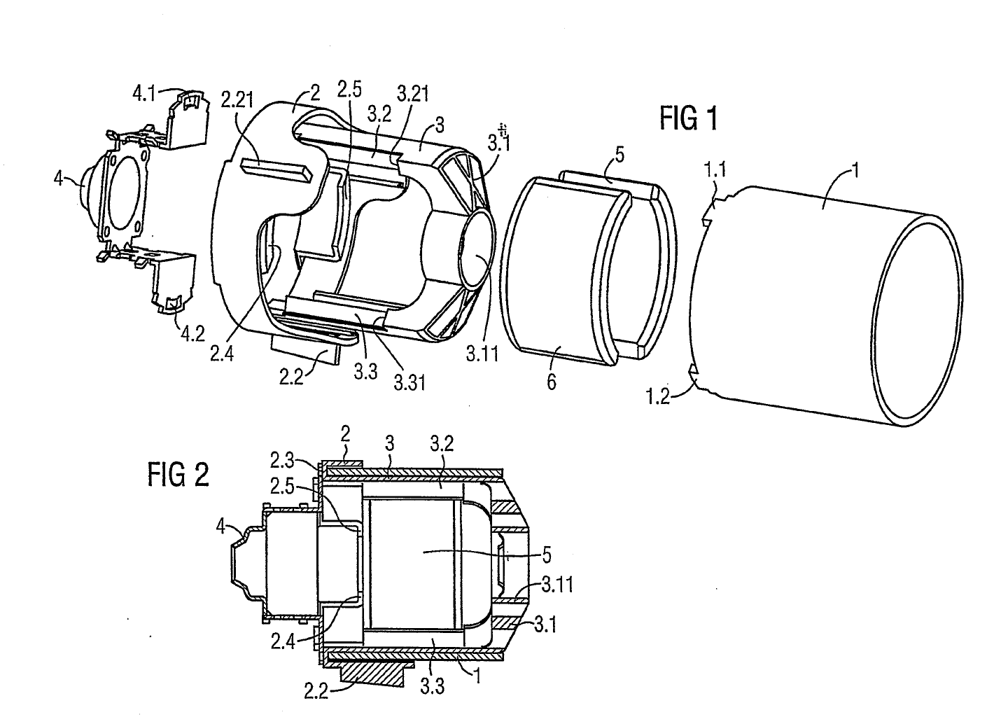

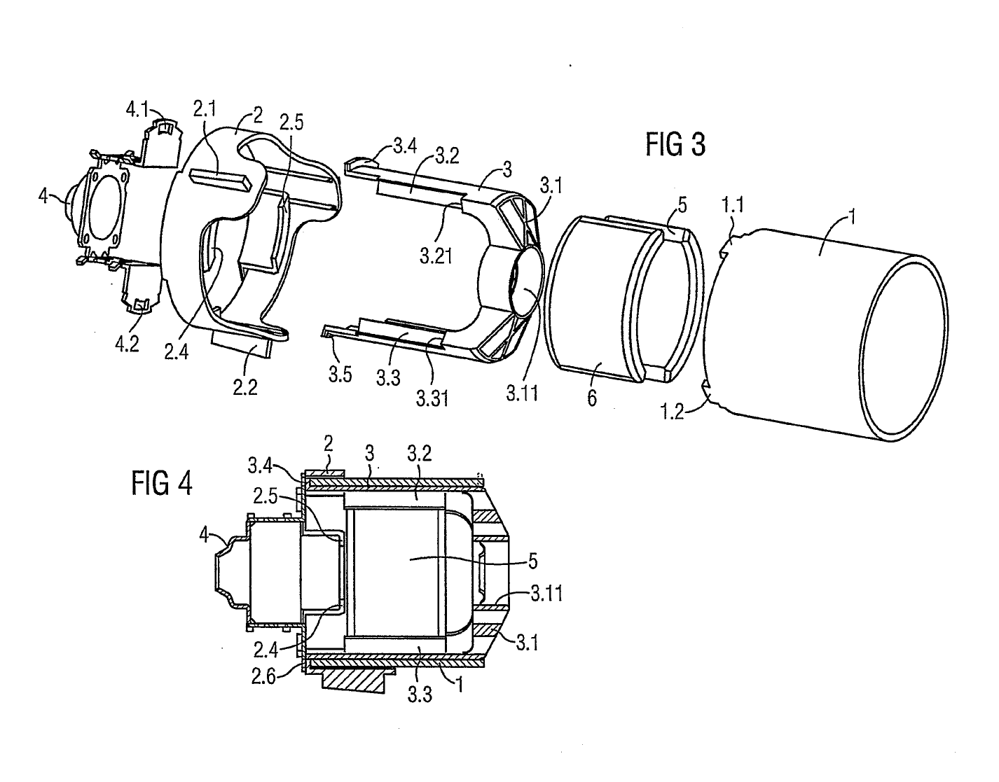

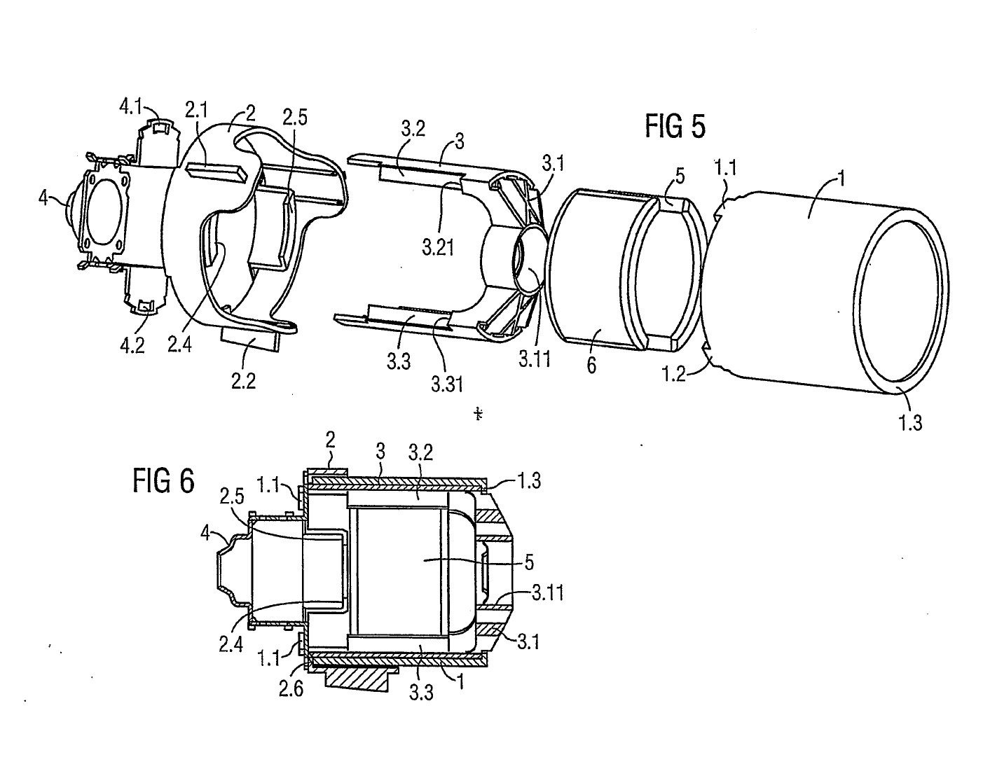

FIGS. 1, 2 and 3, 4 and 5, 6 respectively show a device for the noise-dampened mounting of an electric motor energized by a permanent magnet represented with respect to its stator part, assuming a type known from EP 0 848 477 B1 as mentioned in the introduction, for example; electric motors of this type are used in particular in fan blowers in motor vehicles, and are mounted in a fan housing in a noise-dampened manner.

An intermediate adapter part 2 overlaps a stator reflux part radially in the form of a motor housing 1, and has distributed over its external area in a known manner noise-dampened mounting webs 2.1; 2.2 radially distant in the form of tongues, which press against the electric motor when mounting it in a motor mount, for example a fan housing—as is known, for example, from EP 0 844 477 B1 mentioned in the introduction.

By reducing material use to a minimum, the adapter fixture 3 has a first bearing bracket 3.1 at its one end molded as one piece, optionally with an integrated bearing retainer 3.11, and extends—in the final assembly state of the electric motor—radially within the motor housing 1, has retainers 3.2; 3.3 for exciter magnets that can be inserted axially abutting its tangential front sides in the form of magnet shells 5, 6, and extends with its other end axially to the other bearing bracket 4, so that it can be braced advantageously therewith—as described below on the basis of the different embodiments—together with the intermediate adapter part 2.

The motor housing 1 that can be inserted in axial installation assembly with radial overlap over the adapter fixture 3 and with radial undercut under the intermediate adapter part 2 is provided with clamp tongues 1.1; 1.2, preferably perforated, on its front side facing the other bearing bracket 4, by means of which it can be braced to form a permanent interconnection with the other bearing bracket 4, preferably by means of clamp tongue adapters 4.1; 4.2 molded onto said bearing bracket.

In an advantageous manner, the important components in the form of the adapter fixture 3 integrated with the one bearing bracket 3.1 and accommodating the premountable magnet shells 5, 6, as well as the intermediate adapter part 2 provided with the noise-dampening mounting webs 2.1; 2.2 can be braced at the same time with the motor housing 1 with respect to the other bearing bracket—as described below in greater detail.

In a first embodiment according to FIG. 1, 2, the intermediate adapter part 2 and the adapter fixture 3 are combined using a transition part 2.3 on the front side in the area of the discrete other bearing bracket 4 to form a component that is particularly simple to mount such that the motor housing 1 that can be inserted between intermediate adapter part 2 and adapter fixture 3 can also be fixed when it is braced with the other bearing bracket 4 by means of front-side pressure on the transition part 2.3, the intermediate adapter part 2 and the adapter fixture 3 in their respective final installation position.

In a second embodiment according to FIG. 3, 4, both the intermediate adapter part 2 which is discrete to the adapter fixture 3 as well as the adapter fixture 3 have radial limit stops 2.6 and 3.4; 3.5, respectively, such that they—as in the first embodiment with respect to the transition part 2.3—can also be braced against the other bearing bracket 4 by pressing the motor housing 1; thanks to the adapter parts that can be designed as discrete components and can nevertheless be easily positioned, a high level of installation size variability can be achieved with few means.

In a third embodiment according to FIG. 5, 6 which is otherwise largely equivalent, limit stops 1.3, for example in the form of a circumferential radially projecting collar, are provided on the motor housing 1, through which the adapter fixture 3 can be pressed on from one end against the discrete bearing bracket 4, and thus can in turn be positioned and fixed to the second bearing bracket 4 under normal operating conditions at the same time as the bracing of the motor housing 1.

During the axial installation assembly, a noise-dampened electric motor energized by a permanent magnet that can be incorporated into a motor mount is possible with few components and few as well as simple production steps on the basis of the device according to the invention such that the magnet shells 5; 6 with their tangential front edges abutting the retainers 3.2; 3.3 of the adapter fixture 3 are inserted axially until the front side abuts the axial stop positions 3.21; 3.31 of the intermediate adapter part 3, and the adapter fixture 3 as well as the intermediate adapter part 2 are fixed after the axial attachment or insertion of the motor housing 1 by means of its axial pressure, if the motor housing 1 is clamped to the other separate bearing bracket 4 by means of clamp tongues 1.1 molded thereon according to an embodiment of the invention and corresponding clamp tongue retainers 4.1; 4.2; the axial position of the magnet shells 5; 6 opposite the other end of the electric motor is secured in a particularly simple manner through the axial stop positions 2.4; 2.5 of the intermediate adapter part 2.

In principle, the invention can be summarized as follows: in the sense of an axial construction assembly, an adapter fixture 3 which accommodates magnet shells 5; 6 at the stator end and is provided with a molded-on first bearing bracket 3.1 at one end thereof is directed through a motor housing 1 such that the same radially engages underneath the motor housing while the other end thereof can be positioned and fixed to a second separate bearing bracket 4 along with an intermediate adapter part 2 that overlaps the motor housing 1 and is provided with radial noise-damping mounting webs 2.1; 2.2 with the aid of the motor housing 1 which can be tightly clamped to said second bearing bracket 4.

What is claimed is:

1. An electric motor with mounting device for noise-dampened installation into a radial external motor mounting part, comprising:
a motor housing (1) that can be positioned by means of axial installation assembly between an axial front-side bearing bracket as a stator reflux part for stator-side energizing magnets, respectively,
a noise-dampened intermediate adapter part externally overlapping the motor housing radially at least partially for the noise-dampened accommodation of the electric motor in the radial external motor mounting part,
an adapter fixture engaging under the motor housing for holding the energizing magnets,
the one bearing bracket on the front side being molded on the corresponding one axial end of the adapter fixture, and
a two-way position anchor between the motor housing, the adapter fixture as well as the intermediate adapter part on the one hand and the other bearing bracket that can be mounted on the front side as a separate component on the other hand, created by axially bracing the motor housing with the other bearing bracket.

2. The electric motor with mounting device according to claim 1, comprising:
a configuration of the noise-dampened intermediate adapter part overlapping the motor housing in the area of the other axial end of the adapter fixture.

3. The electric motor with mounting device according to claim 1, wherein
the intermediate adapter part and the adapter fixture respectively being designed as discrete components.

4. The electric motor with mounting device according to claim 1, wherein
the intermediate adapter part and the adapter fixture being designed as a one-piece component able to be mounted in the sense of an axial installation assembly.

5. The electric motor with mounting device according to claim 4, comprising
a one-piece transition from the adapter fixture into the intermediate adapter part in the area of the other end of the adapter fixture.

6. The electric motor with mounting device according to claim 5, wherein
the one-piece transition between the adapter fixture and the intermediate adapter part being braced by fixing the position between the motor housing and the other bearing bracket.

7. The electric motor with mounting device according to claim 1, comprising
radially protruding limit stops at the other end of the intermediate adapter part;
radially protruding limit stops at the other end of the adapter fixture.

8. The electric motor with mounting device according to claim 1, comprising
radially protruding limit stops at the one end of the motor housing,
radially protruding limit stops at the other end of the intermediate adapter part.

9. The electric motor with mounting device according to claim 7, wherein
the intermediate adapter part or the adapter fixture respectively being axially braced by fixing the position between the motor housing and the other bearing bracket via the radially protruding limit stops.

10. The electric motor with mounting device according to claim 1, wherein
tangential front edges of the energizing magnets in the form of magnet shells abut retainers of the adapter fixture or wherein axial front sides of the energizing magnets abut axial limit stops of the adapter fixture or axial limit stops of the intermediate adapter part.

11. The electric motor with mounting device according to claim 10, wherein
the magnet shells are axially braced by fixing the position between the motor housing and the other bearing bracket.

12. The electric motor with mounting device according to claim 1, wherein
the adapter fixture and/or the intermediate adapter part are designed as a plastic part.

13. The electric motor with mounting device according to claim 12, wherein the adapter fixture and/or the intermediate adapter part are designed as a plastic injection molding part.

14. The electric motor with mounting device according to claim 1, wherein the electric motor is a fan motor.

15. The electric motor with mounting device according to claim 8, wherein the radially protruding limit stops are in the form of a circumferential, radially protruding edge.

16. An electric motor with mounting device for noise-dampened installation into a radial external motor mounting part, comprising:
a motor housing positioned between an axial front-side bearing bracket as a stator reflux part for stator-side energizing magnets,
a noise-dampened intermediate adapter part externally overlapping the motor housing radially at least partially for the noise-dampened accommodation of the electric motor in the radial external motor mounting part,
an adapter fixture engaging under the motor housing for holding the energizing magnets,
the one bearing bracket on the front side being molded on the corresponding one axial end of the adapter fixture, and
a mutual fixed position between the motor housing, the adapter fixture as well as the intermediate adapter part on the one hand and the other bearing bracket that can be mounted on the front side as a separate component on the other hand, by axially bracing the motor housing with the other bearing bracket.

17. The electric motor with mounting device according to claim 16, comprising:
a configuration of the noise-dampened intermediate adapter part overlapping the motor housing in the area of the other axial end of the adapter fixture.

18. The electric motor with mounting device according to claim 16, wherein
the intermediate adapter part and the adapter fixture respectively being designed as discrete components.

19. The electric motor with mounting device according to claim 16, wherein
the intermediate adapter part and the adapter fixture being designed as a one-piece component able to be mounted in the sense of an axial installation assembly.

20. The electric motor with mounting device according to claim 19, comprising
a one-piece transition from the adapter fixture into the intermediate adapter part in the area of the other end of the adapter fixture.
